(19) United States
(12) Patent Application Publication
(10) Pub. No.: US 2011/0260444 A1
(43) Pub. Date: Oct. 27, 2011

(54) SAFETY LOCKING DEVICE FOR PIPE CONNECTOR

(76) Inventor: Shen-Chih Lee, Taipei (TW)

(21) Appl. No.: 13/175,877

(22) Filed: Jul. 3, 2011

Related U.S. Application Data
(63) Continuation-in-part of application No. 12/430,899, filed on Apr. 28, 2009.

(51) Int. Cl. F16L 55/00

(52) U.S. Cl. 285/85

(57) ABSTRACT

A safety locking device includes a locking lever pivotally connected to a pipe connector for locking a coupling member, a retaining plate pivotally connected to the pipe connector for stopping the locking lever in the locking position, a lock pin axially movably mounted in a lock hole in the locking lever for engagement with the retaining plate to stop the retaining plate and the locking lever in position, a spring member mounted in the locking lever to force the lock pin into engagement with the retaining plate, and a pull ring for pulling the lock pin from the retaining plate to unlock the locking lever.

### CROSS REFERENCE TO RELATED APPLICATIONS

This application is a Continuation-In-Part of pending U.S. patent application Ser. No. 12/430,899, filed Apr. 28, 2009 and entitled “ SAFETY LOCKING DEVICE FOR PIPE CONNECTOR”.

### BACKGROUND OF THE INVENTION

(a) Field of the Invention

The present invention relates to pipe connectors and more particularly to a safety locking device for pipe connector, which effectively locks the locking lever in the locking position, assuring a high level of safety.

(b) Description of the Related Art

Pipe connectors are intensively used in fluid delivery facilities for quick connection of a connection member of a piping system for delivery of oil or other fluids. A conventional pipe connector, as shown in FIG. 1, comprises a pipe connector body 10 having two pairs of lugs 20 at two sides and two openings 30 corresponding to the lugs 20, and two locking levers 40 respectively pivotally connected to the lugs 20 of the pipe connector body 10. Each locking lever 40 has a cam portion 401 inserted through the adjacent opening 30 for locking the inserted connection member 50 to the pipe connector body 10. This design of pipe connector is not safe in use. When the piping system is being pulled on the floor or when a person or machine touches the locking lever 40 accidentally, the locking lever 40 may be unlocked.

To avoid the aforesaid problem, an improved design was created. According to this design, as shown in FIG. 2, the pipe connector body 10 has an integral locating block 60 and a locating groove 601 on the bottom side of the locating block 60; a lock pin 70 is mounted in the locking lever 40 and supported on a spring member (not shown) for engaging the locating groove 601 to hold the locking lever 40 in the locking position; the locking lever 40 has a rear end connected with a pull ring 80. When the pull ring 80 is pulled to disengage the lock pin 70 from the locating groove 601, the locking lever 40 is released from the constraint and can be biased from the locking position to the unlocking position.

The aforesaid improved pipe connector structure avoids accidental unlocking of the locking lever 40, however the pipe connector body 10 having the said locating block 60 with the said locating groove 601 formed therewith integrally (by casting) is a specially designed structure. In order to use this design of improved pipe connector structure, existing pipe connectors must be replaced. The cost for replacing existing pipe connectors is high. Further, the pull ring 80 is inserted through the bottom end of the lock pin 70 and the rectangular slot 402 of the locking lever 40. When the pull ring 80 is turned accidentally by an external force, the pull ring 80 will be stopped at the top edge of the rectangular slot 402 and the lock pin 70 will be pulled downwardly away from the locating groove 601, thereby losing the safety function.

Pipe connector locking devices equipped with anti-loosing means are known. Exemplars are seen in U.S. Pat. No. 6,364,369B1, U.S. Pat. No. 5,791,694 and U.S. Pat. No. 5,911,445. According to the tube connecting device disclosed in U.S. Pat. No. 6,364,369B1, a securing arm is pivotally mounted to the housing and pivotable from a first, locked position to a second unlocked position, and an actuator is mounted on the arm and a locking member located in a chamber within the arm. According to this design, the whole assembly must be changed if any component part is damaged. Thus, the repair cost would be high. U.S. Pat. No. 5,791,694, entitled “Lock for coupling cam arms”, teaches the use of a low profile locking mechanism for securing a lever arm of a coupler in a locked position. The locking mechanism is formed from low cost resiliently deformable material that is protected against impact by the lever arm. According to this design, the locking tightness is difficult to be controlled. If the engagement between the recesses of the cam arms and the locking mechanism is excessively tight, opening the cam arms will become difficult. However, the locking safety is not ensured if the engagement between the recesses of the cam arms and the locking mechanism is not tight. U.S. Pat. No. 5,911,445 discloses a hose coupling with safety locking means in which two spring and pin sets each having a knob for release control two locking levers are provided for locking the house coupling, two retainer plates are adapted to stop the locking levers in the locking position, and two spring and pin sets are adapted to engage with retainer plates in stopping the locking levers in the locking position, each spring and pin set having a knob for release control. However, the operation of the safety locking means of this design of hose coupling is inconvenient.

### SUMMARY OF THE INVENTION

The present invention has been accomplished under the circumstances in view. It is one object of the present invention to provide a safety locking device for use in any of a variety of conventional pipe connectors to assure a high level of locking safety. It is another object of the present invention to provide a safety locking device for pipe connectors to avoid accidental biasing of the pull ring after the locking lever is locked, assuring a high level of safety.

To achieve these and other objects of the present invention, a safety locking device is pivotally connected to a pipe connector for locking a coupling member, and comprises a locking lever, a lock pin, a spring member, a pull ring and a retaining plate. The locking lever comprises opposing engagement end and operating end, an inner side, an outer side opposite to the inner side, two opposite lateral sides connected between the inner side and the outer side, a pivot hole located on the engagement end and pivotally connected to the pipe connector, a cam-like engagement portion located on the engagement end for locking the inserted coupling member to the pipe connector, a recessed portion located on the inner side and fitting the configuration of the pipe connector, a lock hole located on the operating end and kept in communication with the recessed portion, an elongated slot extending through the two opposite lateral sides across the lock hole and two stop blocks respectively protruding from the two opposite lateral sides between the elongated slot and the outer side. The lock pin is movably inserted into the lock hole of the locking lever, and comprises a front end suspended in the recessed portion and adapted for engaging with the pipe connector, and a rear end extending through the elongated slot. The spring member has one end stopped against the lock pin and an opposite end stopped inside the lock hole of the locking lever and adapted for imparting a pressure to the lock pin to force the front end of the lock pin into the recessed portion of the locking lever. The pull ring is coupled to the elongated slot of the locking lever and the lock pin and stoppable by the stop blocks from being turned outwards relative to the locking lever. The retaining plate comprises a top protrusion extending from a top end thereof, a bottom retaining portion for engagement with the front end of the lock pin, and a through hole located on a middle part thereof corresponding to the pivot hole of the locking lever for pivotally connecting with the locking lever to the pipe connector.

The locking lever and retaining plate of the safety locking device of the present invention are pivotally connectable to the pivot of a conventional pipe connector to substitute for the original locking lever of the pipe connector to enhance the level of safety and saving the cost.

Further, the stop blocks are respectively arranged at the two opposite lateral sides of the locking lever between the elongated slot and the outer side of the locking lever. The stop blocks are so configured that when the front end of the lock pin is forced into engagement with the bottom retaining portion of the retaining plate by the spring member, the stop blocks stop the pull ring from outward biasing. Thus, the pull ring can be biased outwards only when it is pulled downwardly away from the stop blocks. This arrangement prevents accidental action of the lock pin to unlock the locking lever, thus assuring a high level of safety.

### BRIEF DESCRIPTION OF THE DRAWINGS

FIG. 1 is a schematic drawing of a pipe connector according to the prior art.

FIG. 2 is a schematic drawing of another structure of pipe connector according to the prior art.

FIG. 3 is an exploded view of a safety locking device for pipe connector according to the present invention.

FIG. 4 is an exploded view of a pipe connector embodying the present invention.

FIG. 5 is an elevational assembly view of FIG. 4.

FIG. 6 is a sectional side view of FIG. 5.

FIG. 7 corresponds to FIG. 6, illustrating a coupling member inserted into the pipe connector and locked by two safety locking devices.

FIG. 8 corresponds to FIG. 7, illustrating the lock pin disengaged from the retaining plate.

FIG. 9 corresponds to FIG. 8, illustrating the locking levers of the two safety locking devices turned to the respective unlocking positions and the coupling member removed from the pipe connector.

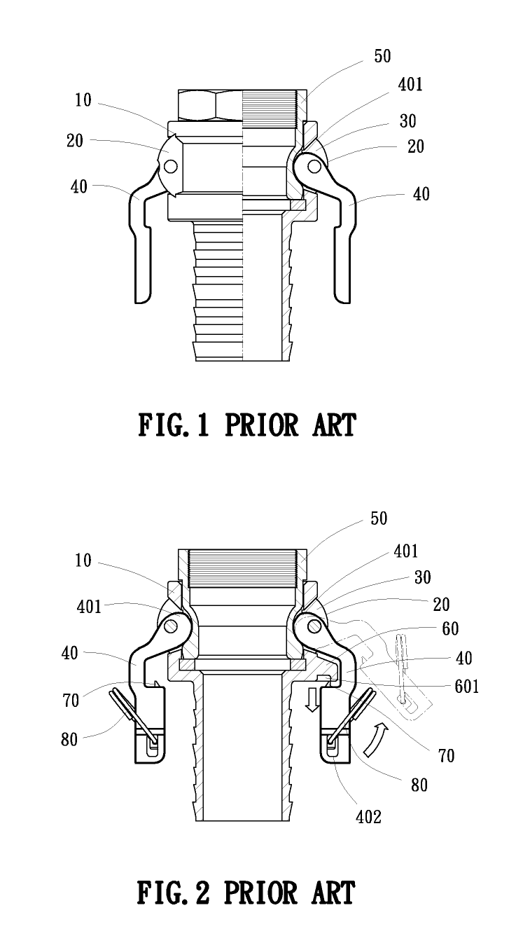

### DETAILED DESCRIPTION OF THE PREFERRED EMBODIMENT

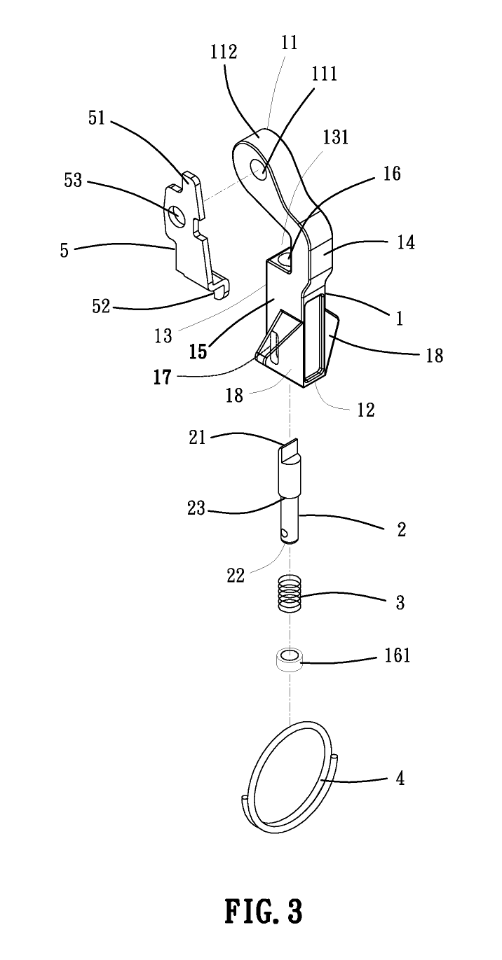

Referring to FIGS. 3, 4 and 7, which show a safety locking device installed in each of two opposite lateral sides of a pipe connector 6 for locking a coupling member 7 to the pipe connector 6. The safety locking device comprises a locking lever 1, a lock pin 2, a spring member 3, a pull ring 4 and a retaining plate 5.

The locking lever 1 is pivotally connected to the pipe connector 6, having opposing engagement end 11 and operating end 12, an inner side 13, an outer side 14 opposite to the inner side 13 and two opposite lateral sides 15 connected between the inner side 13 and the outer side 14. The engagement end 11 defines a pivot hole 111 pivotally connected to the pipe connector 6, and a cam-like engagement portion 112 for locking the coupling member 7 to the pipe connector 6. The inner side 13 defines a recessed portion 131 fitting the configuration of the pipe connector 6. The operating end 12 defines a lock hole 16 in communication with the recessed portion 131. Further, an elongated slot 17 extends through the two opposite lateral sides 15 across the lock hole 16. Further two stop blocks 18 respectively protrude from the two opposite lateral sides 15 between the elongated slot 17 and the outer side 14. Preferably, the stop blocks 18 are triangular blocks.

The lock pin 2 is movably inserted into the lock hole 16 of the locking lever 1, having a front end 21 suspended in the recessed portion 131 and a rear end 22 extending through the elongated slot 17. The front end 21 is adapted for engaging with the pipe connector 6 or the retaining plate 5 at the pipe connector 6.

The spring member 3 has its one end stopped against the lock pin 2, and its other end stopped inside the lock hole 16 of the locking lever 1. Thus, the spring member 3 imparts a pressure to the lock pin 2, forcing the front end 21 of the lock pin 2 into the recessed portion 131 of the locking lever 1 and keeping the front end 21 of the lock pin 2 in engagement with the pipe connector 6 or the retaining plate 5.

The pull ring 4 is a ring member coupled to the elongated slot 17 of the locking lever 1 and the lock pin 2, and stoppable by the stop blocks 18 from being turned outwards relative to the locking lever 1.

The retaining plate 5 has a top protrusion 51 extending from the top end thereof, a bottom retaining portion 52 for engagement with the front end 21 of the lock pin 2, and a through hole 53 located on the middle corresponding to the pivot hole 111 of the locking lever 1 for pivotally connecting with the locking lever 1 to the pipe connector 6.

The locking lever 1, the lock pin 2, the spring member 3, the pull ring 4 and the retaining plate 5 are assembled together, forming the desired safety locking device.

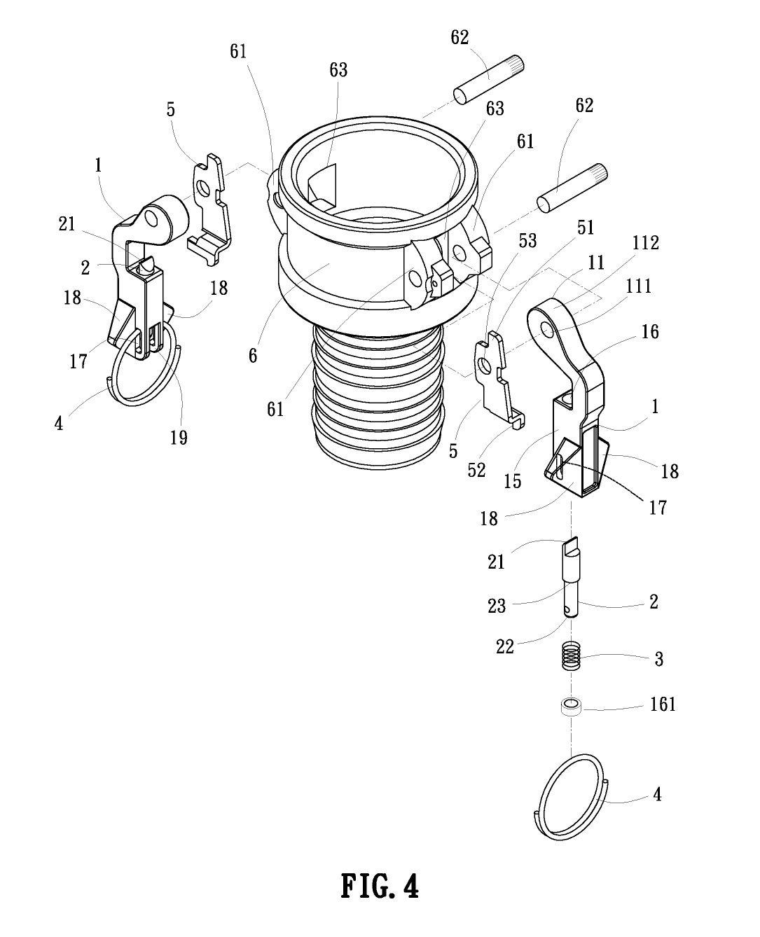

Referring to FIG. 4, the operating end 12 of the locking lever 1 has a notch 19 facing toward the engagement end 11 and kept in communication with the lock hole 16 and adapted for accommodating the rear end 22 of the lock pin 2. Thus, the pull ring 4 is inserted through the elongated slot 17 and the lock pin 2 in the notch 19, and operable to move the lock pin 2.

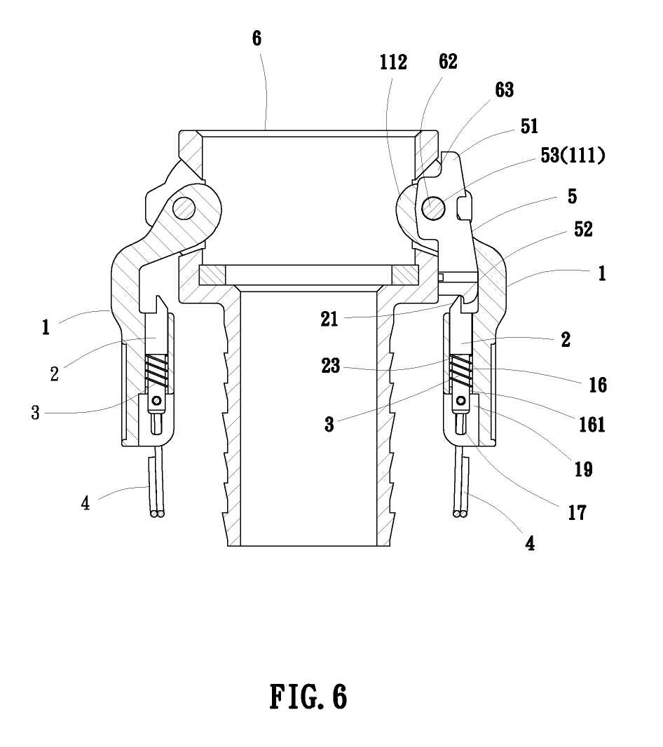

Referring to FIG. 3 and FIG. 6, a stop ring 161 is installed in the lock hole 16 of the locking lever 1 to stop the spring member 3 against the lock pin 2, preventing the spring member 3 from falling out of the lock hole 16. Further, the lock pin 2 has an annular step 23 extending around the periphery. The spring member 3 is sleeved onto the lock pin 2 and stopped between the annular step 23 and the stop ring 161.

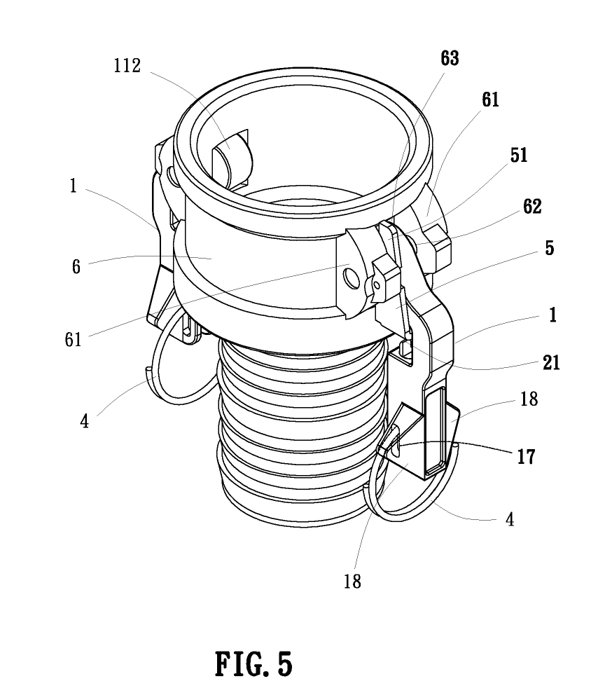

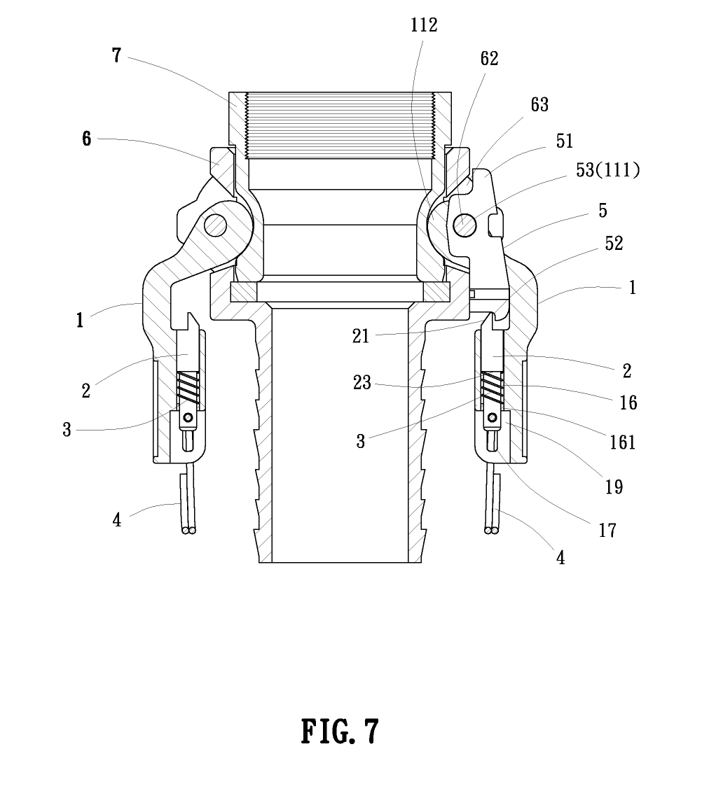

Referring to FIG. 5 and FIG. 6, the pivot hole 111 of the locking lever 1 is pivotally connected between two lugs 61 at one side of the pipe connector 6 by a pivot 62, forcing the engagement portion 112 through an opening 63 on the periphery of the pipe connector 6 between the lugs 61 to lock the coupling member 7 that is inserted into the pipe connector 6 (see FIG. 7). The through hole 53 of the retaining plate 5 is coupled to the pivot 62 such that the retaining plate 5 is disposed at one lateral side relative to the locking lever 1 and stopped with the top protrusion 51 against the top edge of the opening 63 and the bottom retaining portion 52 in engagement with the front end 21 of the lock pin 2. At this position, the retaining plate 5 is prohibited from rotation relative to the pipe connector 6, thereby locking the locking lever 1 and avoiding accidental disengagement between the pipe connector 6 and the coupling member 7.

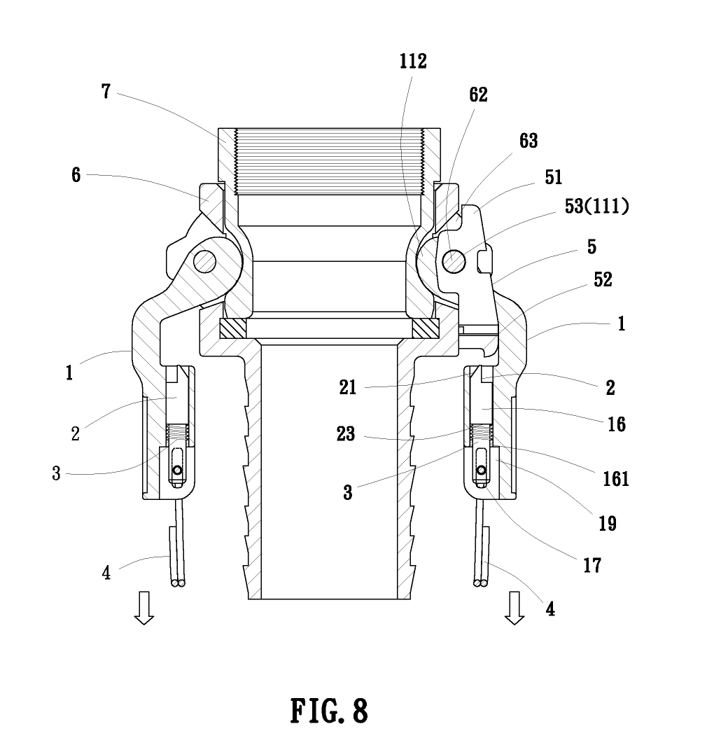

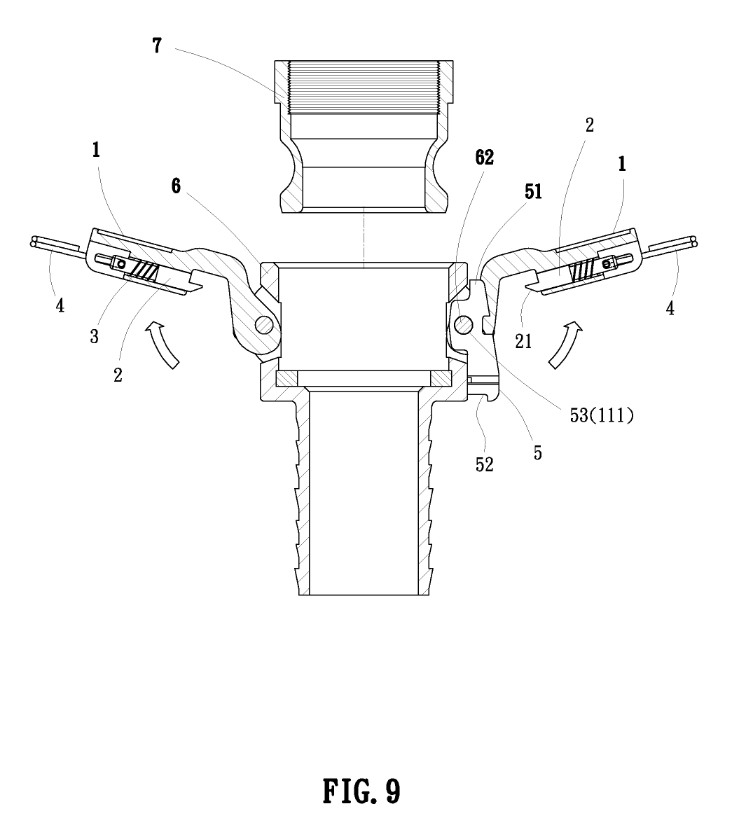

Referring to FIG. 8 and FIG. 9, when removing the coupling member 7 from the pipe connector 6, the pull ring 4 is pulled in the direction toward the operating end 12 of the locking lever 1 to retract the lock pin 2 and to further disengage the front end 21 of the lock pin 2 from the bottom retaining portion 52 of the retaining plate 5. At this position, the locking lever 1 is unlocked and can be biased to disengage the engagement portion 112 from the coupling member 7, thus separating the coupling member 7 from the pipe connector 6.

In conclusion, the invention has the advantages as follows: The locking lever 1 and the retaining plate 5 are pivotally connectable to the pivot 62 of a conventional pipe connector 6 to substitute for the original locking lever of the pipe connector 6, thus enhancing the level of safety and saving the cost at the same time.

Further, the stop blocks 18 are respectively arranged at the two opposite lateral sides 15 of the locking lever 1 between the elongated slot 17 and the outer side 14 of the locking lever 1. The stop blocks 18 are so configured that when the front end 21 of the lock pin 2 is forced into engagement with the bottom retaining portion 52 of the retaining plate 5 by the spring member 3, the stop blocks 18 stop the pull ring 5 from outward biasing. Thus, the pull ring 4 can be biased outwards only when it is pulled downwardly away from the stop blocks 18. This arrangement prevents accidental action of the lock pin 2 to unlock the locking lever 1, thus assuring a high level of safety.

A prototype of the safety locking device for pipe connector has been constructed with the features of FIGS. 3-9. The safety locking device for pipe connector functions smoothly to provide all of the features disclosed above.

Although a particular embodiment of the invention has been described in detail for purposes of illustration, various modifications and enhancements may be made without departing from the spirit and scope of the invention. Accordingly, the invention is not to be limited except as by the appended claims.

The invention claimed is:

1. A safety locking device pivotally connected to a pipe connector for locking a coupling member inserted into the pipe connector, the safety locking device comprising:
a locking lever, said locking lever comprising an engagement end and an opposing operating end, an inner side, an outer side opposite to said inner side, two opposite lateral sides connected between said inner side and said outer side, a pivot hole located on said engagement end and pivotally connected to said quick pipe connector, a cam-like engagement portion located on said engagement end for locking the inserted coupling member to said pipe connector, a recessed portion located on said inner side and fitting the configuration of said pipe connector, a lock hole located on said operating end and kept in communication with said recessed portion, an elongated slot extending through said two opposite lateral sides across said lock hole, and two stop blocks respectively protruding from said two opposite lateral sides between said elongated slot and said outer side;
a lock pin movably inserted into said lock hole of said locking lever, said lock pin comprising a front end suspended in said recessed portion and adapted for engaging with said pipe connector, and a rear end extending through said elongated slot;
a spring member having one end thereof stopped against said lock pin and an opposite end thereof stopped inside said lock hole of said locking lever and adapted for imparting a pressure to said lock pin to force the front end of said lock pin into said recessed portion of said locking lever;
a pull ring coupled to said elongated slot of said locking lever and said lock pin and stoppable by said stop blocks from being turned outwards relative to said locking lever;
a retaining plate comprising a top protrusion extending from a top end thereof, a bottom retaining portion for engagement with the front end of said lock pin, and a through hole located on a middle part thereof corresponding to said pivot hole of said locking lever for pivotally connecting with said locking lever to said pipe connector.

2. The safety locking device as claimed in claim 1, wherein said locking lever further comprises a notch located on said operating end and kept in communication with said lock hole and adapted for accommodating the rear end of said lock pin.

3. The safety locking device as claimed in claim 1, wherein said locking lever further comprises a stop ring mounted in said lock hole and adapted for stopping one end of said spring member against said lock pin.

4. The safety locking device as claimed in claim 3, wherein said lock pin comprises an annular step extending around the periphery thereof; said spring member is sleeved onto said lock pin and stopped between said annular step of said lock pin and said stop ring.
